(19) United States
(12) Patent Application Publication
(10) Pub. No.: US 2008/0050501 A1
(43) Pub. Date: Feb. 28, 2008

(54) Mixtures of high fructose corn syrup (HFCS) 42 or HFCS 55 and high-intensity sweeteners with a taste profile of pure HFCS 55

(76) Inventor: Susanne RATHJEN, Darmstadt (DE)

Correspondence Address: PROPAT, L.L.C., 425-C SOUTH SHARON AMITY ROAD, CHARLOTTE, NC, 28211-2841, US

(21) Appl. No.: 11/861,338

(22) Filed: Sep. 26, 2007

Related U.S. Application Data
(63) Continuation of application No. 10/638,721, filed on Aug. 11, 2003, now abandoned.

(51) Int. Cl. A23L 1/236; A23L 1/09; A23L 2/38; A23L 2/60

(52) U.S. Cl. 426/590; 426/658

(57) ABSTRACT

The invention relates to a mixture with a sweetness and taste profile of pure sucrose (=standard=100 wt.-%), which mixture comprises only 30 to 50 wt.-% (based on the standard) of D) one or more compounds selected from the group consisting of: HFCS 55 and HFCS 42 and E) 0.09 to 0.33 wt.-% (based on the standard) of a mixture of either Acesulfame K and Aspartame or Acesulfame K and Sucralose.

### CROSS-REFERENCE TO RELATED APPLICATIONS

This application is a continuation of co-pending U.S. application Ser. No. 10/638,721, filed Aug. 11, 2003, to which it claims priority. Co-pending U.S. application Ser. No. 10/638,721 is hereby incorporated by reference herein in its entirety.

### A) BACKGROUND OF THE INVENTION

High fructose corn syrups are isomerized corn syrups derived from the isomerization of glucose in the syrup to fructose by the enzyme isomerase. In certain regions syrups with levels of 42% fructose and 55% fructose are mainly used in beverages instead of sugar for cost reasons although it is well known that it is impossible to achieve the same high taste quality of sugar.

High intensity sweeteners are synthetic or natural substances, which have no or virtually no calories and a sweetness potency several times higher than sugar. High intensity sweeteners or blends of high intensity sweeteners are used in food and beverages to achieve a sweet taste without adding calories to the products. High intensity sweeteners commonly used are acesulfame K, alitame, aspartame, cyclamate, lo han go, neohesperidine dihydrochalcone, neotame, saccharin, stevioside and sucralose.

The ongoing debate on obesity in developed countries and the growing health consciousness of consumers lead to an increasing demand of beverages with at least 50% calorie reduction compared to products fully sweetened with carbohydrates and a taste profile similar to the sweetness standard sugar.

However, no high-intensity sweetener matches the taste profile of sugar completely. They differ in characteristics such as sweetness profile, side taste and off-taste characteristics. Proper blending of different high intensity sweeteners is known to overcome part of the taste limitations of single high-intensity sweeteners. But even if a more sugar-like sweetness profile is achieved in products with high-intensity sweeteners only, they still can be distinguished sensorically from their counterparts with just sugar by lack of mouthfeel and reduced flavour characteristics.

Fry (Sugar replacement in non-diet soft drinks, Food Technology International Europe, 83-86, 1995) describes 30 and 50% calorie reduced sweetening concepts in cola and lemonades using combinations of either glucose syrup and aspartame or low-fructose syrups and aspartame. Using a consumer panel it was shown that the taste profile of none of these sweetening systems was similar to sucrose. In fact the glucose syrup/aspartame and low-fructose syrup aspartame mixtures showed statistically significant differences in sweetness, acidity, sweet aftertaste, bitter aftertaste, length of aftertaste, liking for aftertaste, mouthfeel, odour liking, flavour liking and overall liking.

Simon (Simon et al., Combinations of glucose syrups and intense sweeteners, application in calorie reduced soft drinks. In ‘FIE. Food ingredients Europe. Conference proceedings, Paris 27, 28, 29 Sep. 1989’. Maarssen, Netherlands; Expoconsult Publishers, 330-333, 1989) recommends using 3% glucose syrup and different combinations of high-intensity sweeteners, which are calculated from a computer model without giving any sensory description of their taste profiles compared to sugar.

Lotz and Meyer (Lotz, A., Meyer, E.: Sweeteners in beverages—New developments, Food Marketing & Technology, 4-9, 1994.) recommend recipes using sugar and sweetener blends stating that these combinations create a “nicely balanced sweetness” without showing any sensory results compared to sugar.

Meyer (Meyer, H.: Keep it sweet—The role of aspartame in developing healthy and nutritionally balanced foods and drinks, Agrofood Industry, 25-27, 2003) shows that no significant difference could be observed by consumers testing a sugar sweetened Cola vs. a product sweetened with 60% sugar and 40% aspartame in a triangle test.

Thus, no proper blending of different high intensity sweeteners alone or mixtures with HFCS at carbohydrate replacement levels of at least 50% is known, which matches the taste profile of sucrose sufficiently.

It was therefore an objective for the present invention to develop a mixture of either HFCS 42 and/or 55 as cheaper carbohydrate sources than sucrose plus high intensity sweetener blends having a taste profile similar to sucrose with at least 50% calorie reduction compared to the fully-sugared product.

### SUMMARY OF ADVANTAGEOUS EMBODIMENTS OF THE INVENTION

The present invention, therefore, relates to a mixture with a sweetness and taste profile of pure sugar (=standard=100 wt.-%), which mixture comprises only 30-50, preferably 35-50 wt.-% (based on the standard) of
B) one or more compounds selected from the group consisting of: HFCS 55 and HFCS 42
C) 0.09-0.33, preferably 0.10-0.30, especially preferred 0.11-0.27 wt.-% (based on the standard) of a mixture of either Acesulfame K and Aspartame or Acesulfame K and Sucralose

### BRIEF DESCRIPTION OF THE DRAWINGS

FIG. 1 is a sensory profile of beverages containing two comparative sweetener compositions: 10 wt.-% sucrose vs. 10.15 wt.-% (solids) HFCS 42

FIG. 2 is a sensory profile of further beverages containing comparative sweetener compositions: 10.15 wt.-% (solids) HFCS 55 vs. 10 wt.-% sucrose;

FIG. 3 is a sensory profile of beverages containing an advantageous reduced calorie sweetener composition in accordance with Example 3 in comparison to sucrose;

FIG. 4 is a sensory profile of beverages containing advantageous reduced calorie sweetener composition in accordance with Example 4 in comparison to sucrose;

FIG. 5 is a sensory profile of beverages containing advantageous reduced calorie sweetener composition in accordance with Example 5 in comparison to sucrose; and

FIG. 6 is a sensory profile of beverages containing a comparative sweetener composition in accordance with Comparative Example 6 in comparison to sucrose.

### DETAILED DESCRIPTION OF ADVANTAGEOUS EMBODIMENTS OF THE INVENTION

Although neither HFCS 42 or HFCS 55 nor blends of Acesulfame K/Aspartame or Acesulfame K/Sucralose match the taste profile of sucrose as such completely, surprisingly it was observed that certain mixtures of either HFCS 55 or HFCS 42 plus either Acesulfame K/Aspartame or Acesulfame K/Sucralose have a taste profile which is not significantly different from sucrose with at least 50% calorie reduction.

The weight ratio of the two high intensity sweeteners in the mixtures are:

Acesulfame K/Aspartame 20/80 to 70/30 (w/w), preferably 25/75 to 60/40 (w/w) and especially preferred 30/70 to 55/45 (w/w);

Acesulfame K/Sucralose 10/90 to 80/20 (w/w), preferably 30/70 to 75/25 (w/w) and especially preferred 40/60 to 70/30 (w/w).

These mixtures of carbohydrate sweeteners with high intensity sweeteners meet the objective of partial carbohydrate replacement using HFCS 55 and/or HFCS 42 as carbohydrate source and at least 50% calorie reduction and can be used in e.g. beverages. Suitable beverages according to the invention are all alcoholic beverages and non-alcoholic beverages (water based, fruit-juice based, milk- or milk-derivative based), either carbonated or non-carbonated, in concentrated form or ready-to drink, preferably all alcoholic beverages and non-alcoholic beverages (water based and fruit juice based), either carbonated or non-carbonated, in concentrated form or ready-to drink, especially preferred all non-alcoholic beverages (water based and fruit-juice based), either carbonated or non carbonated, in concentrated form or ready-to drink.

The mixtures may also contain minor amounts, i.e. up to 10 wt.-%, preferably up to 5 is wt.-% of commonly used additives such as flavours, bulking agents weighting agents etc.

The mixture is prepared by simply mixing HFCS 55 and/or HFCS 42 with Acesulfame K and Aspartame or Acesulfame K and Sucralose.

The invention further provides for a process for partially replacing carbohydrates (=standard sucrose=100 wt.-%) using HFCS 55 and/or 42 as carbohydrate source, under retention of the sweetness and taste profile of sucrose, which process comprises reducing the amount of carbohydrate sweetener to 30-50 wt.-%, preferably 35-50 wt.-% of the standard and adding 0.09-0.33 wt.-%, preferably 0.10-0.30, especially preferred 0.11-0.27 wt.-% (based on the sucrose standard) of a mixture of either Acesulfame K and Aspartame or Acesulfame K and Sucralose.

The weight ratio of the two high intensity sweeteners are as shown above for the mixtures.

The invention is further illustrated by the following, non-limiting, examples.

### EXAMPLES

Methodology

The sensory analysis was carried out in soft drinks. All sweetening systems employed were sensorically adjusted to 10% (weight) sucrose equivalence. A sensory panel of experts, especially trained to evaluate sweet products, from an independent, experienced sensorial-testing institute established the beverage flavour-specific attributes for the quantitative descriptive analysis. Quantitative assessments were undertaken by each of 12 panellists in individual tasting booths using a 0-100 scale. The order of presentation of samples was balanced across the panellists. Each panellist completed 3 replicates of these quantitative rating assessments.

### Comparative Example 1

10.15 wt.-% (Solids) HFCS 42 vs. 10 wt.-% Sucrose in a Lemon-Lime Carbonated Beverage

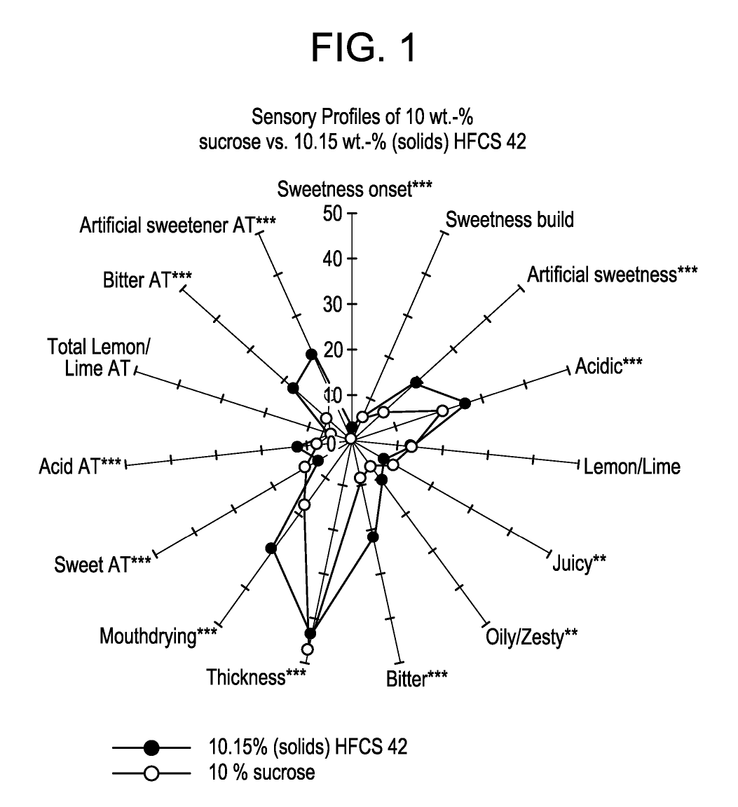

The sensory profiles of a 10.15 wt.-% (solids) HFCS 42 sweetened lemon-lime product vs. a product sweetened with 10 wt.-% sucrose are shown in the spider diagram at FIG. 1. Statistically significant sensory differences between the two products were observed, as indicated in FIG. 1. In FIG. 1, significant differences are shown by superscript notes at attributes, with the superscript notes indicating:
* significantly different at 90% confidence level,
** significantly different at 95% confidence level,
*** significantly different at 99% confidence level.
Beverage system: commercially available lemon-lime flavour (Sensient 1013981), 2.5 g/l citric acid monohydrate, 0.15 g/l sodium benzoate, 6.3 g/l CO₂

The spider diagram shows a multi parameter graph, describing the overall taste and sweetness profile of food products. The different attributes itself like e.g. acidity or sweet AT (after taste) as well as the intensity of these attributes are the result of a multi test person sensory panel trial.

The size area integral itself does not have any meaning. However, the shape of the respective integral characterises the taste profile as such. Thus, the more the area integral of two different types of food products e.g. beverages show a similar shape or form, the better the taste profiles can be described as being not significantly different from each other.

### Comparative Example 2

10.15 wt.-% (Solids) HFCS 55 vs. 10 wt.-% Sucrose in a Lemon-Lime Carbonated Beverage

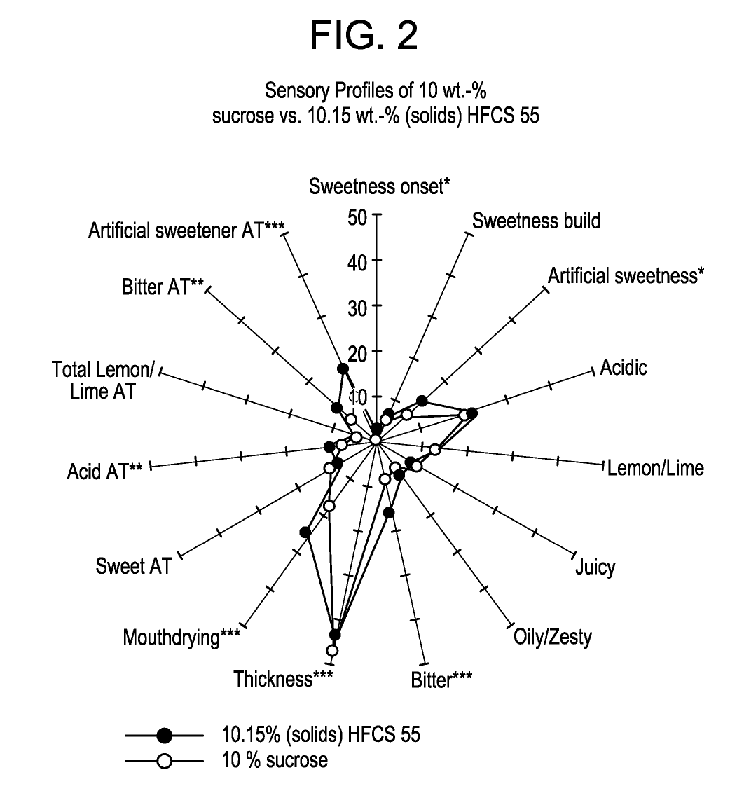

The sensory profiles of a 10.15 wt.-% (solids) HFCS 55 sweetened lemon-lime product vs. a product sweetened with 10 wt.-% sucrose are shown in the spider diagram at FIG. 2. Statistically significant sensory differences between the two products were observed, as indicated in FIG. 2. As in FIG. 1, significant differences in FIG. 2 are shown by superscript notes at attributes, with the superscript notes indicating:
* significantly different at 90% confidence level,
** significantly different at 95% confidence level,
*** significantly different at 99% confidence level.
Beverage system: commercially available lemon-lime flavour (Sensient 1013981), 25 2.5 g/l citric acid monohydrate, 0.15 g/l sodium benzoate, 6.3 g/l CO₂

### Example 3

10 wt.-% Sucrose vs. 5 wt.-% (Solids) HFCS 55+Aacesulfame K/Sucralose in a Lemon-Lime Carbonated Beverage

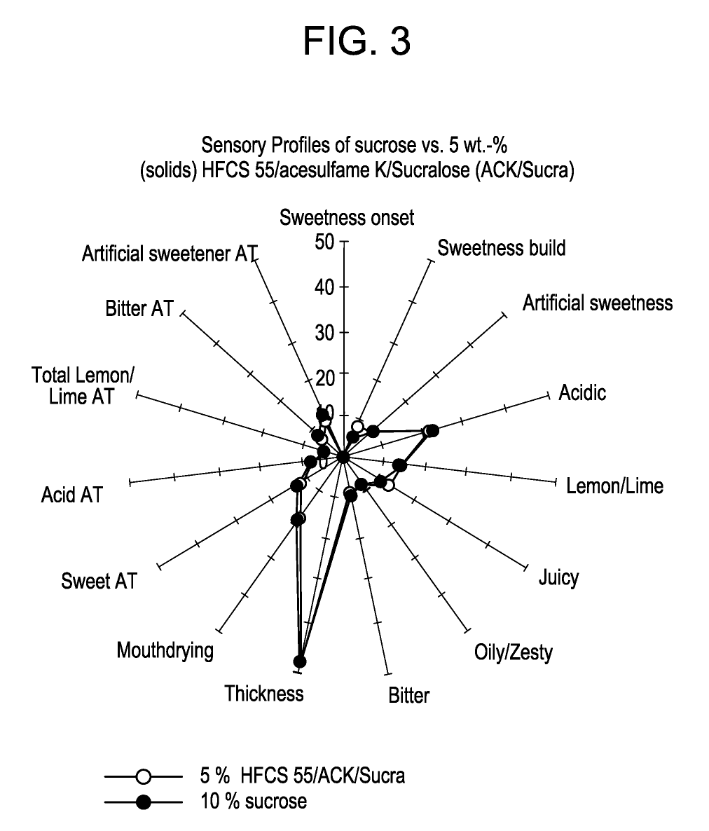

The sensory profiles of a 10 wt.-% sucrose sweetened lemon-lime product vs. a product sweetened with 5 wt.-% (solids) HFCS 55 plus a acesulfame K/Sucralose are shown in the spider diagram at FIG. 3. No statistically significant sensory differences between the two products were observed (alpha=0.01), as indicated in FIG. 3, providing sensory profiles of sucrose vs. 5 wt.-% (solids) HFCS 55/acesulfame K/Sucralose (ACK/Sucra).

| | |
|---|---|
| Beverage system: | commercially available lemon-lime flavour (Sensient |
| | 1013981), 2.5 g/l citric acid monohydrate, 0.15 g/l |
| | sodium benzoate, 6.3 g/l CO2 |
| Sweetening | 10 wt.-% sucrose; 5 wt.-% (solids) HFCS |
| systems: | 55 + 0.062 g/l acesulfame K + 0.057 g/l Sucralose |

### Example 4

10 wt.-% Sucrose vs. 3.5 wt.-% (Solids) HFCS 55+Acesulfame K/Aspartame in a Lemon-Lime Carbonated Beverage

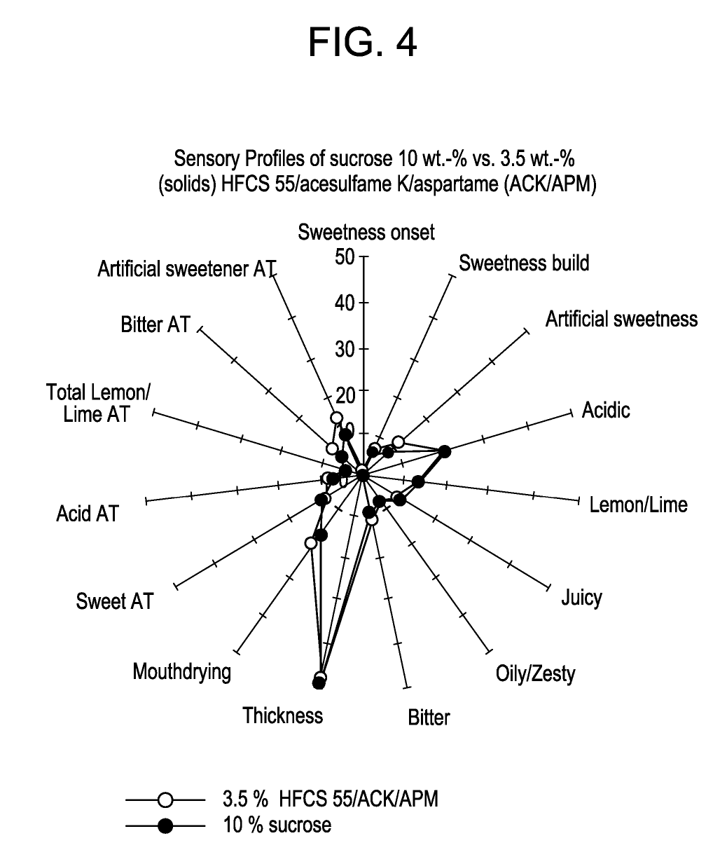

The sensory profiles of a 10 wt.-% sucrose sweetened lemon-lime product vs. a product sweetened with 3.5 wt.-% (solids) HFCS 55 plus acesulfame K/aspartame are shown in the spider diagram at FIG. 4. No statistically significant sensory differences between the two products were observed (alpha=0.01), as indicated in FIG. 4 providing sensory profiles of 10 wt.-% sucrose vs. 3.5 wt.-% (solids) HFCS 55/acesulfame K/aspartame (ACK/APM).

| | |
|---|---|
| Beverage system: | commercially available lemon-lime flavour (Sensient |
| | 1013981), 2.5 g/l citric acid monohydrate, 0.15 g/l |
| | sodium benzoate, 6.3 g/l CO2 |
| Sweetening | 10 wt.-% sucrose; 3.5 wt.-% (solids) HFCS |
| systems: | 55 + 0.088 g/l acesulfame K + 0.088 g/l aspartame |

### Example 5

10 wt.-% Sucrose vs. 5 wt.-% (Solids) HFCS 42+Acesulfame K/Sucralose in a Lemon-Lime Carbonated Beverage

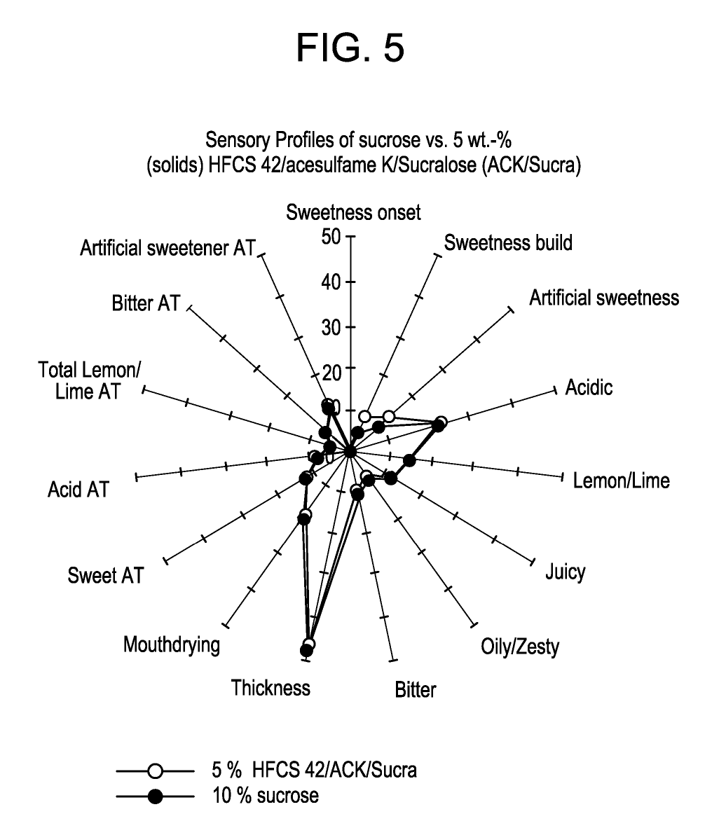

The sensory profiles of a 10 wt.-% sucrose sweetened lemon-lime product vs. a product sweetened with 5 wt.-% (solids) HFCS 42 plus acesulfame K/Sucralose are shown in FIG. 5. No statistically significant sensory differences between the two products were observed (alpha=0.01), as indicated in FIG. 5, providing sensory profiles of sucrose vs. 5 wt.-% (solids) HFCS 42/acesulfame K/Sucralose (ACK/Sucra)

| | |
|---|---|
| Beverage system: | commercially available lemon-lime flavour (Sensient |
| | 1013981), 2.5 g/l citric acid monohydrate, 0.15 g/l |
| | sodium benzoate, 6.3 g/l CO₂ |
| Sweetening | 10 wt.-% sucrose; 5 wt.-% (solids) HFCS |
| systems: | 42 + 0.068 g/l acesulfame K + 0.063 g/l Sucralose |

### Comparative Example 6

10 wt.-% Sucrose vs. 5 wt.-% (Solids) HFCS 42+Sucralose in a Lemon-Lime Carbonated Beverage

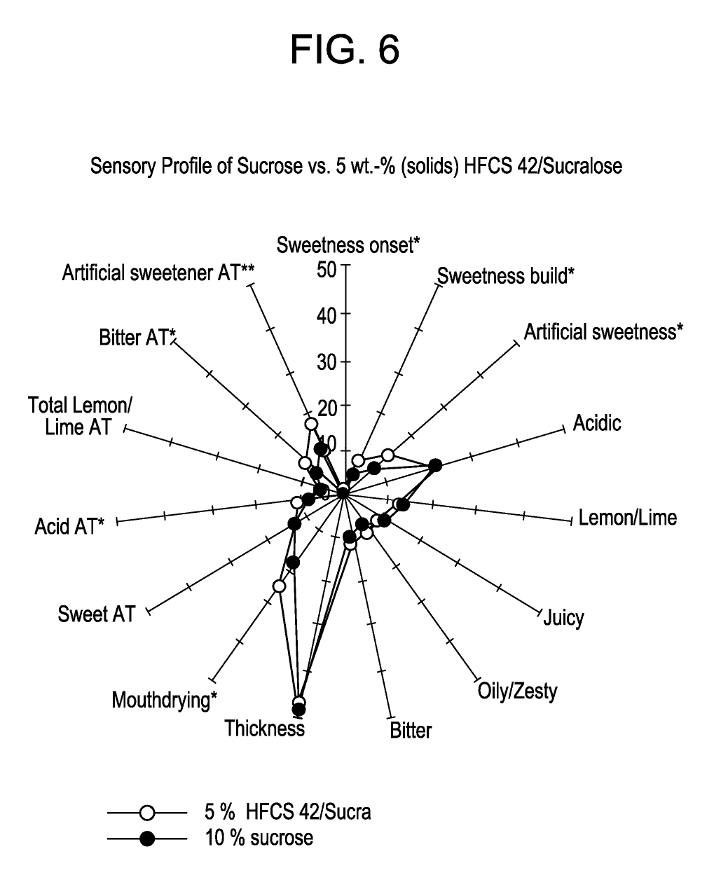

The sensory profiles of a 10 wt.-% sucrose sweetened lemon-lime product vs. a product sweetened with 5 wt.-% (solids) HFCS 42 plus Sucralose are shown in the spider diagram at FIG. 6. Statistically significant sensory differences between the two products were observed, as indicated in FIG. 6, providing the sensory profiles of sucrose vs. 5 wt.-% (solids) HFCS 42/Sucralose (Sucra)

As in FIGS. 1 and 2, significant differences are shown in FIG. 6 by superscript notes at attributes, with the superscript notes indicating:
* significantly different at 90% confidence level,
** significantly different at 95% confidence level,

*** significantly different at 99% confidence level.

| | |
|---|---|
| Beverage system: | commercially available lemon-lime flavour (Sensient |
| | 1013981), 2.5 g/l citric acid monohydrate, 0.15 g/l |
| | sodium benzoate, 6.3 g/l CO₂ |
| Sweetening | 10 wt.-% sucrose; 5 wt.-% (solids) HFCS |
| systems: | 42 + 0.083 g/l Sucralose |

That which is claimed:

1. A mixture with a sweetness and taste profile of pure sucrose (=standard=100 wt.-%) which mixture comprises only 30 to 50 wt.-% (based on the standard) of
A) one or more compounds selected from the group consisting of: HFCS 55 and HFCS 42 and
B) 0.09 to 0.27 wt.-% (based on the standard) of a single binary mixture of high intensity sweeteners, wherein said binary mixture of high intensity sweeteners is either Acesulfame K and Aspartame or Acesulfame K and Sucralose.

2. Mixture as claimed in claim 1, wherein the mixture comprises only 35 to 50 wt.-% of one or more compounds selected from the group consisting of: HFCS 55 and HFCS 42.

3. Mixture according to claim 1, wherein the mixture comprises 0.10 to 0.27 wt.-% of a mixture of either Acesulfame K and Aspartame or Acesulfame K and Sucralose.

4. Mixture according to claim 1, wherein the weight ratio of Acesulfame K to Aspartame is 20/80 to 70/30 (w/w).

5. Mixture according to claim 1, wherein the weight ratio of Acesulfame K to Aspartame is 25/75 to 60/40 (w/w).

6. Mixture according to claim 1, wherein the ratio of Acesulfame K/Sucralose is 10/90 to 80/20 (w/w).

7. Mixture according to claim 1, wherein the ratio of Acesulfame K/Sucralose is 30/70 to 75/25 (w/w).

8. Process for partially replacing a carbohydrate sweetener (=standard=100 wt.-%) under retention of the sweetness and taste profile of the carbohydrate sweetener, which process comprises reducing the amount of carbohydrate sweetener to 30 to 50 wt.-% of the standard and adding 0.09 to 0.27 wt.-% (based on the standard) of a mixture of either Acesulfame K and Aspartame or Acesulfame K and Sucralose.

9. Process as claimed in claim 8, wherein the amount of carbohydrate sweetener is reduced to 35 to 50 wt.-%.

10. Process according to claim 8, wherein 0.10 to 0.27 wt.-% of a mixture of either Acesulfame K and Aspartame or Acesulfame K and Sucralose is added.

11. Process according to claim 8, wherein the weight ratio of Acesulfame K to Aspartame is 20/80 to 70/30 (w/w).

12. Process according to claim 8, wherein the weight ratio of Acesulfame K to Aspartame is 25/75 to 60/40 (w/w).

13. Process according to claim 8, wherein the ratio of Acesulfame K/Sucralose is 10/90 to 80/20 (w/w).

14. Process according to claim 8, wherein the ratio of Acesulfame K/Sucralose is 30/70 to 75/25 (w/w).

15. Beverage comprising a mixture according to claim 1.

16. A mixture according to claim 1, wherein said mixture consists essentially of
A) one or more compounds selected from the group consisting of: HFCS 55 and HFCS 42,
B) a single binary mixture of high intensity sweeteners and
C) one or more optional additives selected from flavours, bulking agents and weighting agents.

17. A mixture according to claim 1, wherein the sweetness and taste profile of said mixture does not significantly differ from the sweetness and taste profile of pure sucrose on a quantitative descriptive analysis using fifteen sensory descriptors at a 90 to 99% confidence level.
